(19) United States
(12) Patent Application Publication
(10) Pub. No.: US 2007/0251797 A1
(43) Pub. Date: Nov. 1, 2007

(54) Wrap spring torque transfer device and method for improving service life of such device

(76) Inventor: John F. Hehl SR., Delevan, NY (US)

Correspondence Address: CANTOR COLBURN, LLP, 55 GRIFFIN ROAD SOUTH, BLOOMFIELD, CT, 06002, US

(21) Appl. No.: 11/415,132

(22) Filed: May 1, 2006

(51) Int. Cl. F16D 27/00

(52) U.S. Cl. 192/84.81

(57) ABSTRACT

A wrap spring torque transfer device including a housing, a shaft rotatably positioned at the housing, a hub rotatably positioned at the housing, a wrap spring disposed about the hub and the shaft; and capable of selectively facilitating or defeating torque transfer between the hub and the sleeve, a coil in magnetic flux communication with the housing, shaft and hub, such that the magnetic flux passes the hub and sleeve to draw the hub and sleeve together. A method for improving service life of a wrap spring torque transfer device including passing a magnetic flux radially between a housing and a flange mounted to a shaft, passing the flux axially between the flange and a collar, passing the flux radially between the collar and a sleeve at the shaft, substantially avoiding flux passage directly between the collar and the housing.

### BACKGROUND

A conventional, electromagnetically actuated, wrap spring clutch includes a shaft, a shaft sleeve disposed about the shaft and connected for rotation therewith, a flange rotationally fixed to the shaft, and a hub. The hub is also disposed about the shaft, but may rotate independently of the shaft when the wrap spring clutch is de-energized. The clutch further includes a coil substantially disposed about the shaft sleeve and an annular wrap spring disposed about a portion of the hub and a portion of the shaft sleeve. A first end of the wrap spring is connected to the hub so that the spring rotates with the hub. A second end of the wrap spring is disposed radially outwardly of the shaft sleeve and is free of the shaft sleeve when the clutch is de-energized. Energizing the coil establishes magnetic flux circuits or closed loops in the magnetically permeable portions of the clutch. Upon such energization, attractive forces arising from the generated magnetic flux draw the second end of the spring by way of the collar into communication with the flange thereby causing relative rotation between the first and second ends of the spring. Such will cause the spring to reduce or grow in inside dimension depending upon direction of the relative rotation. Where the spring diminishes in inside dimension, it tightens on the hub and shaft sleeve, thereby transmitting torque between the hub and the shaft sleeve. This causes the shaft and hub to rotate together in a torque transmitting condition.

While such devices are commercially available and generally function well for their intended purposes, they suffer from wear that limits service life to a questionably acceptable term. Typically, wear in the bearing that supports the shaft can cause operational failure as well as can wear of the shaft sleeve by the wrap spring itself at a point known in the industry as the “cross-over point”. This leads to the spring positioning itself in a developing annular space between the shaft sleeve and the hub and results ultimately in spring breakage. A wrap spring torque transfer device having a longer service life would benefit the art.

### SUMMARY

A wrap spring torque transfer device including a housing, a shaft rotatably positioned at the housing, a hub rotatably positioned at the housing, a wrap spring disposed about the hub and the shaft; and capable of selectively facilitating or defeating torque transfer between the hub and the sleeve, a coil in magnetic flux communication with the housing, shaft and hub, such that the magnetic flux passes the hub and sleeve to draw the hub and sleeve together.

A wrap spring torque transfer device including a housing, a shaft rotatably positioned at the housing, the shaft including a flange rotationally affixed thereto, a hub rotatably positioned at the housing, a wrap spring disposed about the hub and the shaft; and capable of selectively facilitating or defeating torque transfer between the hub and the sleeve, a collar in operable communication with the wrap spring and responsive to a magnetic field to engage or disengage the flange, and a coil in magnetic flux communication with the housing, flange and collar, such that the magnetic flux passes radially from the housing to the flange and axially from the flange to the collar.

A method for improving service life of a wrap spring torque transfer device including causing a magnetic attraction at a crossover point between a shaft and a hub of the device.

A method for improving service life of a wrap spring torque transfer device including passing a magnetic flux radially between a housing and a flange mounted to a shaft, passing the flux axially between the flange and a collar, passing the flux radially between the collar and a sleeve at the shaft, substantially avoiding flux passage directly between the collar and the housing.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross sectional view of a wrap spring torque transfer device;

FIG. 2 is a cross section view of a shaft with components that are permanently rotatable therewith;

FIG. 3 is a cross section view of a hub with components that are permanently rotatable therewith;

FIG. 4 is a perspective view of hub ring of the device;

FIG. 5 is a perspective view of a wrap spring to selectively bridge the shaft and hub for torque transfer; and

FIG. 6 is a cross sectional view of a wrap spring torque transfer device identical to FIG. 1 except that a magnetic flux path is shown in a heavy line.

### DETAILED DESCRIPTION

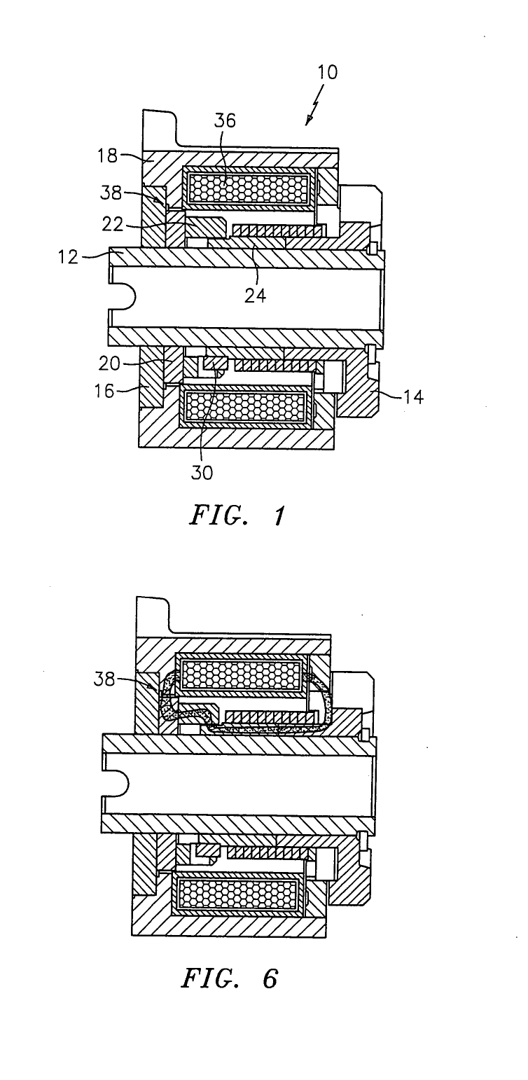

Referring to FIG. 1, a wrap spring torque transfer device 10 is illustrated. It is noted initially that the transfer of torque can be effected in “either direction” or stated another way input torque can be on the shaft or on the hub and out put torque can be on the other of the shaft or the hub. The device works in both directions. For purposes of discussion and for brevity, the description following assumes that the input torque is applied to the shaft 12 at the left end of FIG. 1; the output torque then will be found at the hub 14 at the right end of FIG. 1. Reversal of this direction is contemplated herein.

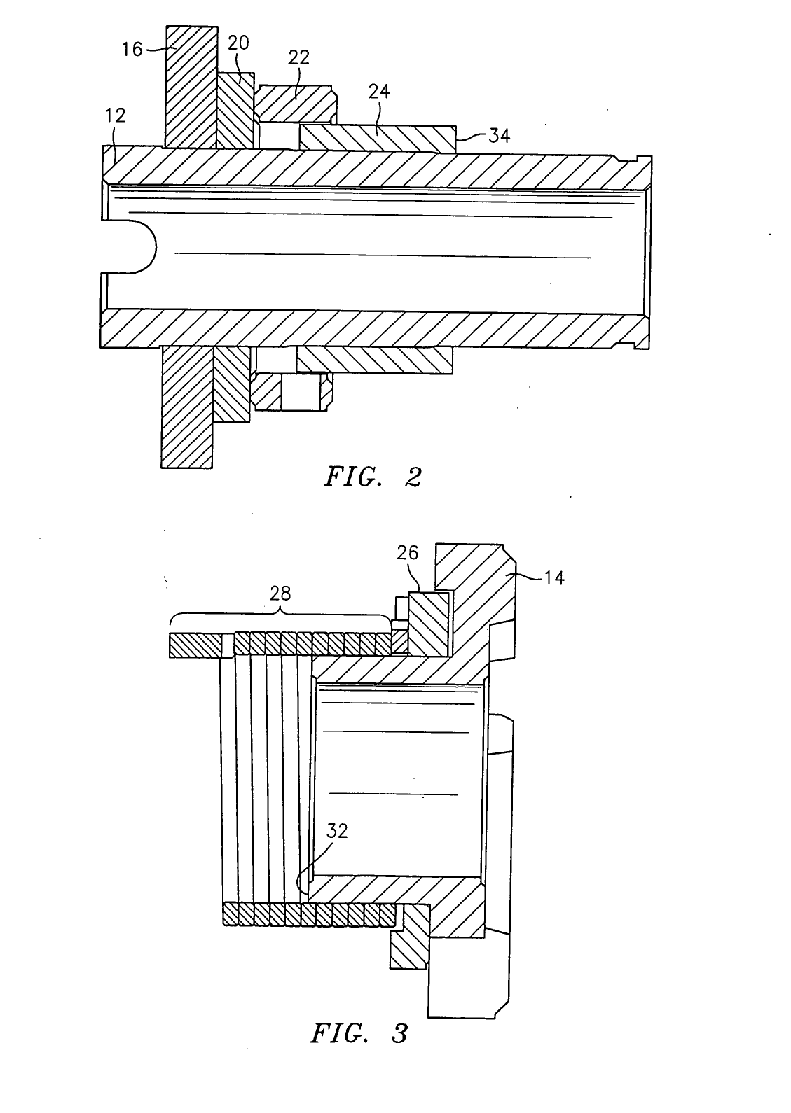

Addressing construction of the shaft 12 first, reference is made to FIGS. 1 and 2, simultaneously. The non-magnetic shaft 12 includes several components that are non-rotationally attached thereto. Beginning arbitrarily from the left side of figure two, the first structure represented on shaft 12 is a bearing 16. The bearing is rotationally fixed to the shaft by means of an interference fit or a profile, etc. and functions to support the shaft rotatably in a housing 18. Adjacent the bearing 16 is a flange 20 that likewise is non-rotationally affixed to the shaft 12. The flange is constructed of a magnetically permeable material as it is intended to be a part of the flux path of the device 10. Neither the bearing nor the flange is axially movable on the shaft.

Next adjacent the flange 20 is a collar 22 that is rotationally free from the shaft 12. While the collar 22 is illustrated in contact with the flange 20, this is the engaged position; a disengaged position will provide a space between the flange and the collar sufficient to allow relative rotational movement therebetween without wear at the interface of these two components. The collar 22 is axially moveable responsive to magnetic flux to actuate the device 10. Collar 22 is consequently constructed of a magnetically permeable material so that it will be a part of the magnetic flux path of the device 10 when a magnetic field is generated.

Next adjacent the collar is a torque transfer sleeve 24, which is rotationally affixed to the shaft 12. The sleeve too is magnetically permeable and plays host to flux occurring during the generation of a magnetic field. Like the bearing noted above, the other non-rotatable components at the shaft may be made so by a number of means including interference fit, splines, profiled interconnection, bonding, etc.

The components 12, 16, 20 and 24 illustrated in FIG. 2 all rotate together regardless of whether they function as the input end of the device 10 or the output of the device 10. The components illustrated in FIG. 2 are also illustrated in FIG. 1 and thereby show their relative positions within the device 10. It will be appreciated from FIG. 1 that only the bearing provides a gapless fit with the housing 18 while the other components are arranged in clearance bores within the housing 18.

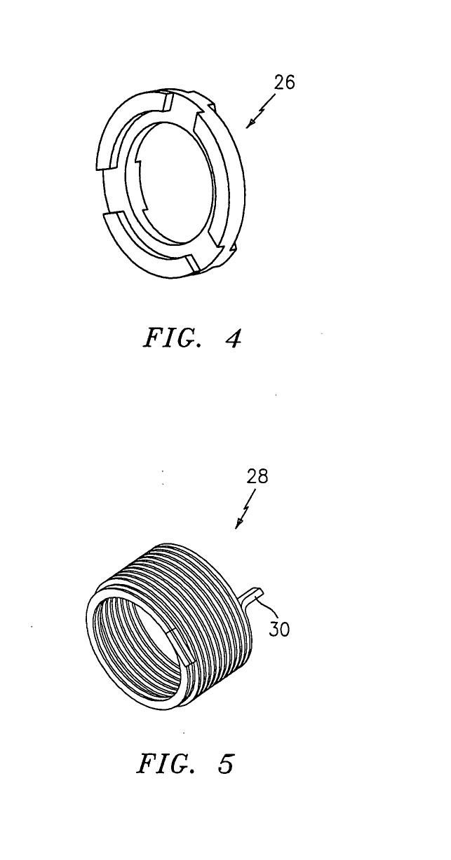

Moving to FIG. 3, the hub 14 is illustrated with components that rotate therewith. These include, beginning arbitrarily from the right side of the figure, a hub ring 26 (perspective view illustrated in FIG. 4) that functions to rotationally anchor a wrap spring 28 (perspective view illustrated in FIG. 5), the spring also being anchored at its other end 30 to collar 22 (as shown in FIG. 1). As one will appreciate from the FIG. 3 illustration, the wrap spring extends beyond an end surface 32 of the hub 14 by a selected distance. By referring to FIG. 1, one will appreciate that this distance partially extends over the sleeve 24. The interface between hub 14 and sleeve 24 at end 32 of hub 14 and a respective end 34 of sleeve 24 (see FIG. 2) is what is known as the “crossover point”. It is at the crossover point that one of the benefits of the presently disclosed configuration provides benefit. As was noted in the background section of this application, end 34 tends to be worn by the spring 28 over time. This is in large part due to an axial spreading of the ends 32 and 34 due to the action of the wrap spring. Ultimately, the wear is enough to allow the spring to move into the groove worn thereby and cause breakage thereof. The configuration hereof dramatically reduces or eliminates this wear and therefore improves the service life of the device 10. The mode of operation of the device, discussed hereunder will provide further information as to how the configuration hereof avoids the identified wear.

Referring back to figure one, the components illustrated in FIGS. 3, 4, and 5 join their counterparts illustrated in FIG. 2 as an assembly of device 10. Further illustrated in figure one but not yet introduced is a coil 36. The coil 36 is fed an applied voltage to create a magnetic field, the use of which by the device causes torque transfer, or alternatively an end of torque transfer. The alternative utilities for device 10 depend upon relative rotation direction, that is, whether engagement of the collar will increase the inside dimension of the spring 28 or decrease the inside dimension of the spring 28. If the inside dimension is increased, then torque transfer will be abated while if the inside dimension is reduced, the result is that the spring clamps down on the sleeve 24 and torque is transferred.

Relative rotation of the hub ring 26 and the collar 22 is occasioned by the collar being drawn into contact with the flange 20 by a magnetic field generated by the coil 36. The flux path of the field is illustrated in FIG. 6 in a heavy line (FIG. 6 is otherwise identical to FIG. 1). The generated flux path has two effects: the first is to draw the collar 22 against the flange 20 as stated and the other is to draw the sleeve end 34 into contact with hub end 30 to alleviate wear at end 34. The magnetic attraction between the end 32 and end 34 effectively make the sleeve 24 and hub 14 behave substantially like a single piece of material, thereby effecting the reduced wear as stated. Reduced wear, lengthens the time before which the spring may bind in the crossover point (which it might never do with the disclosed configuration) thereby improving the service life of the device 10. Additionally, the flux path created in the disclosed configuration passes between the housing ID at 38 (see FIGS. 1 and 6) through an air gap at that location and does not pass from the housing inside dimension to the collar 22. This is a distinction over the prior art that provides the additional benefit that as the bearing 16 wears, even if the flange 20 contacts the housing, the wrap spring function will be retained. In the disclosed device, a much larger gap is usable between the collar and the housing to prevent interference therebetween. In prior art configurations, since the flux path is between the housing inside dimension and the collar 22 outside dimension, the air gap there would have to be tight. In such configurations, as the bearing wears, the collar itself will contact the housing and defeat operation of the device altogether. The current configuration will cause noise to emanate from the device 10 but function will be maintained for a period of time. Such a period would normally be a reasonable period to effect repairs.

In accordance with the provisions of the patent statutes, the present invention has been described in what is considered to represent its preferred embodiment. However, it should be noted that the invention can be practiced otherwise than as specifically illustrated and described.

1. A wrap spring torque transfer device, comprising:
a housing;
a shaft rotatably positioned at the housing;
a hub rotatably positioned at the housing;
a wrap spring disposed about the hub and the shaft; and capable of selectively facilitating or defeating torque transfer between the hub and the sleeve;
a coil in magnetic flux communication with the housing, shaft and hub, such that the magnetic flux passes the hub and sleeve to draw the hub and sleeve together.

2. The wrap spring torque transfer device as claimed in claim 1 wherein the wrap spring is rotationally anchored to the hub at one end of the wrap spring.

3. The wrap spring torque transfer device as claimed in claim 1 wherein the hub and sleeve when magnetically energized behave substantially as a single component.

4. The wrap spring torque transfer device as claimed in claim 2 wherein the wrap spring is rotationally anchored at another end to a collar.

5. The wrap spring torque transfer device as claimed in claim 4 wherein the collar is engageable with a flange, the flange being rotationally affixed to the shaft.

6. The wrap spring torque transfer device as claimed in claim 5 wherein the collar is engageable via a magnetic field generated by the coil.

7. The wrap spring torque transfer device as claimed in claim 5 wherein when the collar is engaged with the flange, relative rotation between the collar and the hub causes the wrap spring to change in inside dimension thereby facilitating or defeating torque transfer between the shaft and hub.

8. The wrap spring torque transfer device as claimed in claim 7 wherein the spring is reduced in inside dimension consequently transferring torque between the shaft and hub.

9. The wrap spring torque transfer device as claimed in claim 7 wherein the spring is enlarged in inside dimension consequently defeating transfer of torque between the shaft and hub.

10. A wrap spring torque transfer device, comprising:
a housing;
a shaft rotatably positioned at the housing, the shaft including a flange rotationally affixed thereto;
a hub rotatably positioned at the housing;
a wrap spring disposed about the hub and the shaft; and capable of selectively facilitating or defeating torque transfer between the hub and the sleeve;
a collar in operable communication with the wrap spring and responsive to a magnetic field to engage or disengage the flange; and
a coil in magnetic flux communication with the housing, flange and collar, such that the magnetic flux passes radially from the housing to the flange and axially from the flange to the collar.

11. The wrap spring torque transfer device as claimed in claim 10 wherein magnetic flux is substantially avoided between the housing inside dimension and the collar outside dimension.

12. A method for improving service life of a wrap spring torque transfer device comprising causing a magnetic attraction at a crossover point between a shaft and a hub of the device.

13. A method for improving service life of a wrap spring torque transfer device comprising:
passing a magnetic flux radially between a housing and a flange mounted to a shaft;
passing the flux axially between the flange and a collar;
passing the flux radially between the collar and a sleeve at the shaft, substantially avoiding flux passage directly between the collar and the housing.

14. The method as claimed in claim 13 further comprising:
passing the flux between the sleeve and a hub, thereby mitigating sleeve-to-hub axial separation upon wrap spring actuation.
